(19) United States
(12) Patent Application Publication
(10) Pub. No.: US 2010/0293945 A1
(43) Pub. Date: Nov. 25, 2010

(54) NATURAL ENERGY CONVERSION AND ELECTRICITY GENERATION SYSTEM

(76) Inventor: Richard M. Connell, Algona, WA (US)

Correspondence Address: JENSEN + PUNTIGAM, P.S., 2033 6th Ave, Suite 1020, SEATTLE, WA, 98121, US

(21) Appl. No.: 12/783,466

(22) Filed: May 19, 2010

Related U.S. Application Data
(60) Provisional application No. 61/179,372, filed on May 19, 2009.

(51) Int. Cl. F03G 3/04

(52) U.S. Cl. 60/639

(57) ABSTRACT

An energy-creating and storage device and method wherein a stored natural fluid is used to generate electricity which is both used and stored, and the fluid, after having driven the electricity producing turbine, is recirculated to be used again or channeled to a series of cascading units to capitalize on the remaining energy.

### TECHNICAL FIELD

This invention relates to the generation of electricity through the use of natural energy and the utilization of naturally occurring fluid in combination with mechanical tools and natural forces to create an advantage sufficient to generate enough electricity to satisfy a given customer or consumer and to share with others as well as replenishing or recirculating the fluid to allow its use in the generation of more electricity.

### BACKGROUND OF THE INVENTION

Natural energy is available throughout the world in various forms such as natural wind, falling water or tidal and wave energy. Heretofore, it has not been feasible to utilize large quantities of natural energy in the production of electricity having an alternating current except in somewhat difficult circumstances. For example, windmills have been used for the production of electricity, although such use has typically been limited to production of smaller amounts of electricity. Water energy, including both tidal and wave energy, has been used in the production of electricity but, again, the use has not been shown to be economically feasible in large scale. Finally, electricity has been produced directly from natural solar energy although once again, such production of electricity is not economically feasible in the grand scale.

Conventional sources of energy for production of electricity, such as oil, gas, coal, wood and hydraulics through the use of dams are in an ever dwindling supply which necessitates that natural forms of energy be utilized to a greater extent in the future. Natural forms of energy are effectively inexhaustible and are typically available in one form or another throughout the world. The problem of global warming must also be taken into consideration.

Unfortunately, both the average and peak demands for electrical energy in homes and in industries are typically out of phase with the availability of natural sources of energy. For example, tidal and wave action, although somewhat predictable, oftentimes do not coincide with the time at which peak electrical energy is required. Similarly, solar energy is most abundant during the middle of the day, whereas the peak demand for electrical energy often occurs later in the evening and gradually decreases thereafter. Accordingly, it is necessary that natural energy be somehow stored so as to be releasable during those periods of average and peak demand.

The most common method of storing electrical energy is with batteries. Large storage batteries have been developed on a commercial basis and have been used both in agriculture and in industry. Electrical storage batteries, however, are objectionable due to problems relating to maintenance and reliability. Furthermore, electrical storage batteries are limited to providing electrical energy having a direct current, and such DC electricity is not compatible with the vast majority of conventional appliances and motors.

Prior art known to the present inventor includes: U.S. Pat. No. 4,206,608 granted Jun. 10, 1980 to Bell, which discloses utilizing natural energy to produce alternate current electricity, wherein the natural energy is utilized to pressurize hydraulic fluid which is stored and then used to generate electricity through known devices; U.S. Pat. No. 4,767,938 granted Aug. 30, 1988 to Bervig, which discloses a fluid dynamic energy-producing device; U.S. Patent Publication No. 2008/0131830 published Jun. 5, 2008, invented by Nix, discloses the use of renewable energy such as solar, wind, geothermal, biomass and hydropower form.

### SUMMARY OF THE INVENTION

With the above-noted prior art in mind, it is a goal of the present invention to generate energy of various types through the efficient use and reuse of natural resources.

It is another goal of the present invention to utilize the energy of a stored fluid to generate electrical energy and then, through the utilization of mechanical force multipliers, generate sufficient electrical energy to recirculate the fluid, as well as providing energy for other useful purposes.

It is a further goal of the present invention to utilize natural energy sources in a manner that the process converts natural energy to electrical energy, which can be stored as well as used, while simultaneously recirculating the fluid energy such that it can be reutilized for the same purpose.

### BRIEF DESCRIPTION OF THE DRAWINGS

FIG. 1 is a schematic showing the present invention in its most comprehensive form.

FIG. 2 is a schematic showing the present invention in a cascading format.

FIG. 3 illustrates a turbine with a power transmission device; the direct drive unit includes a circuit equipped with a power transmission device.

FIG. 4 illustrates a turbine with a power transmission device connected to an alternator generator.

### BEST MODE FOR CARRYING OUT THE INVENTION

As will be readily apparent from the following description, the intent and purpose of the current invention is to provide a local reusable source of energy; and through the utilization of mechanical or other advantages, create sufficient energy such that the source of energy, in this case a cascading fluid, can be recirculated and reused. The fluid necessary for enabling the process can come from a body of water, including oceans, lakes, rivers, retention ponds, storm drains, wells, groundwater or rainwater. The water is screened and filtered so it is otherwise free from debris or sediment, which may interrupt the process. The motive fluid is contained in a vessel, which obviously includes an inlet from the fluid source, and it could be either vented to the atmosphere for gravity feed or have valves to allow for pressurization of the fluid. The vessel would include an overflow vessel, to be explained hereinafter, but each vessel would include an outlet tube or a penstock which is the way that the vessel provides the fluid under pressure to devices downstream. The penstock could include a larger size at the vessel connection and have a decreased diameter at the outlet end to increase the pressure at the point of discharge. It is envisioned in this embodiment that the penstock would process an impulse-type turbine similar to a Pelton wheel having a disproportionately distributed or added weight to the outer runner edge. The amount of weight would be determined by the needs of the consumer, and the weight would have the effect of preloading the turbine, similar to a flywheel, reducing the amount of fluid flow, pressure and torque needed to cause rotation of the turbine. The breakaway or full torque load will be higher initially to start the rotation of the turbine.

The design and construction of the turbine is such that it provides the fluid with a mechanical advantage and this includes various means to connect the turbine to power transmission and other devices. These power transmission devices include, but are not limited to, sprockets, pulleys, gears, torque multiplying gears, fluid power circuits and the like. Also in this illustrative embodiment, the power transmission device connected to the turbine is intended to provide the turbine with further mechanical advantage to operate a fluid pump connected to a fluid power circuit. The present invention includes as an integral portion thereof a fluid power circuit which includes a means to connect or accept connection with a turbine, including a power transmission device and a power output device. This provides a reduction in torque and rpm needed to operate an appropriately sized fluid motor. The fluid motor may be connected directly to an electrical generator. The connection may be done by a direct drive connection or by a connection first made to a power transmission device. Elements of the process include means for connecting or linking of the fluid power circuits to enhance the potential for mechanical advantage. Fluid power accumulators may be present in each of the circuits and may be used to accumulate and store for use excess flow not used by the fluid motors. The stored energy may be used to power other functions or circuits. These other functions or circuits are used to facilitate the generation of more electrical or mechanical power for output or in the motive fluid recirculation portion of the process. Fluid control valves or flow dividers may be used in the circuits, but these do not store energy. They may be used to make use of bypass or unused fluid to power other fluid functions or circuits.

Synchronous, induction-type or alternator generators may be used in the process.

A feature of the present invention includes means to recirculate motive fluid. This allows for taking full advantage of all available potential energy sources within the process. After the fluid has spent its energy causing the rotation of the turbine, it falls and is collected in a tail race. In other hydropower processes known, the tail race is the point where the fluid ends its use and exits from the process. In the present invention, the tail race is the beginning of the recirculation process. The fluid trapped in the tail race falls into a vessel and repeats the process described hereinabove. However, at this time, it is not to generate electrical energy to be used by the consumer; instead, the energy is used to recirculate the fluid back to the beginning point to begin the cycle again. An electric generator may be used to facilitate this or, alternatively, a hydraulic drive pump may be used. Other unused energy from previous stages in addition to mechanical energy may be used to recirculate the motive fluid to complete the cycle. It is to be understood that the apparatus and process as described hereinabove can be multiplied by stacking multiple units so that as the fluid falls from the first unit, it would land in the vessel of the second or successive units, then circulate back to the beginning point, which would leave all electrical power generated for other uses. It is to be understood that the embodiments of this process can be stacked as high as needed or that space is available.

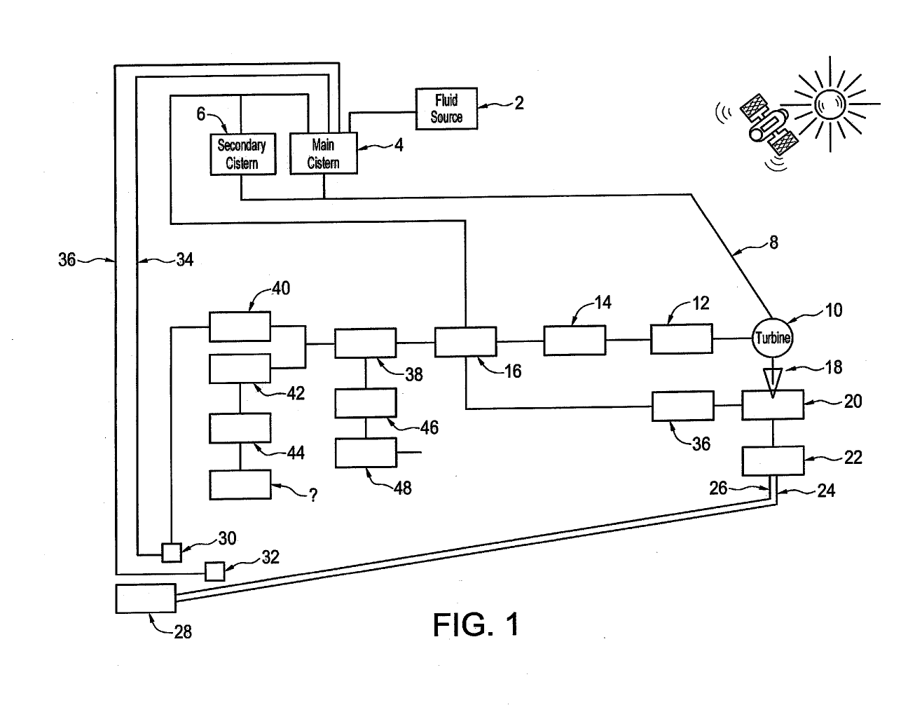

Reference is now had to FIG. 1, wherein the fluid source 2, such as described hereinabove, is designated as a rectangle in the flow diagram which provides the fluid into the main cistern. Water from either the main cistern or the secondary cistern 6 flows through the penstock 8 to the main turbine 10. The main turbine 10, through means described hereinabove, drives the power transmission device 12, which again as described hereinabove drives the alternator generator 14, which is directly connected to an energy storage device 16. The fluid, after exiting the turbine 10, travels via tail race 18 and could pass through a potential energy device 20, or alternatively go to a sump 22 through a tail race 24 or a tail race overflow 26 to a tail race catch basin or sump 28.

Adjacent the sump or catch basin 28 is an electric fluid return device 30 or a mechanical fluid return device 32, used to transport the fluid via conduits 34, 36 to the main cistern 4.

Power from the potential energy device 20 travels to the generator 36 and to the energy storage device 16. Power from the energy storing device 16 can go to a power distribution system 38 to power the electric fluid return device 30.

Power from the energy storing device 16 could likewise go to power the fluid return 40, a motor 42, and be a supplier for any useful purpose 44.

Excessive heat from the power distribution system could go to a thermal dump 46 and be used to power a Stirling engine 48 for a useful purpose.

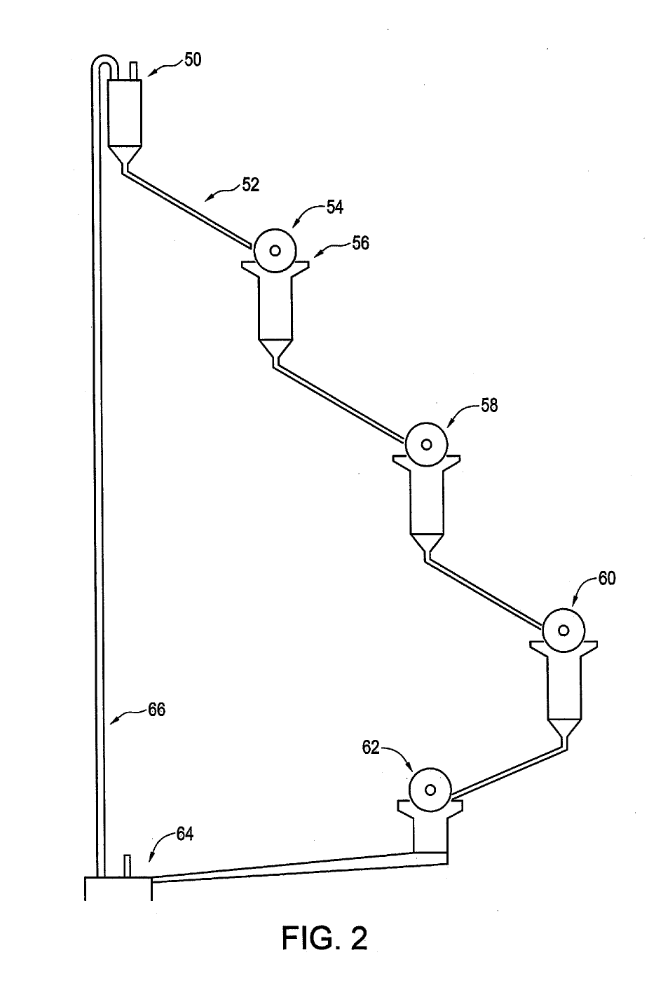

Reference is now had to FIG. 2, wherein the cascading feeding system of the hydroelectric generating process is described. As seen in this view, the vessel 4 containing the motive fluid 50, which may include overflow vessels, drains into a penstock 52, employing the principle of volume reduction to conserve mass and build pressure. This may also include alternatively an adjustable nozzle for directing motive fluid at the turbine 54, which may be an impulse or reaction-type turbine and may include a standard flywheel or have weight evenly distributed to the outside of the runner edge. Constructed to provide mechanical advantage, the turbine is operatively connected to a power transmission device via roller chain sprockets or the equivalent. This power transmission device is operatively connected to another energy-generating device, such as an electrical generator or other type power transmission device, such as a fluid power circuit, which is then connected to an energy-generating device. Depending upon the overall height of the system, a single turbine may exist; or where the overall height allows, a plurality of turbines may be used, with at least a portion of the energy generated used to recirculate the fluid.

Power sources 58, 60 and 62 are essentially replicas of 54-56, wherein the energy could be generated for other uses, including production of potable water or to generate the energy needed to recirculate the motive fluid. The fluid will eventually be collected in a fluid recirculation vessel 64, completing the circuit. This vessel could be the initial point for allowing fluid to enter the system from its source, or may be recirculated to the vessel containing motive fluid 50 via the fluid return pipe 66.

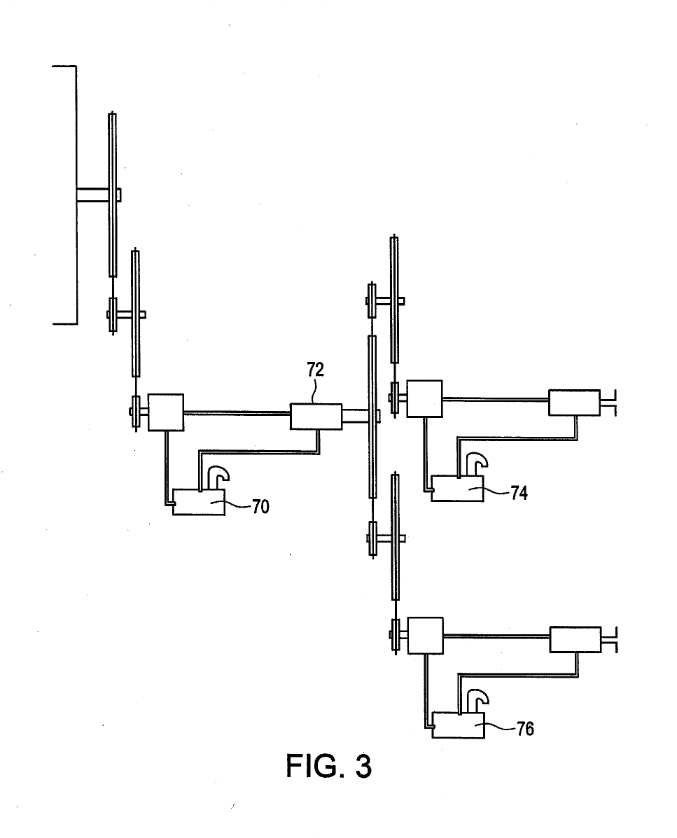

FIG. 3 illustrates a turbine with a power transmission device connected to a fluid circuit. This is connected to a plurality of fluid circuits. For example, this could be a large pump 70 operating well below rated speed and could provide full operational flow to a smaller motor 72. This motor with its own power transmission device could connect to a plurality of fluid pumps 74-76, and these pumps could also combine their flow and pressure to power a fluid motor. This would allow the use of a single turbine to generate the energy needed to drive electrical generators and water pumps, making the production of electricity, potable water and recirculate the motive fluid in a low head configuration to maximize potential energy of the system.

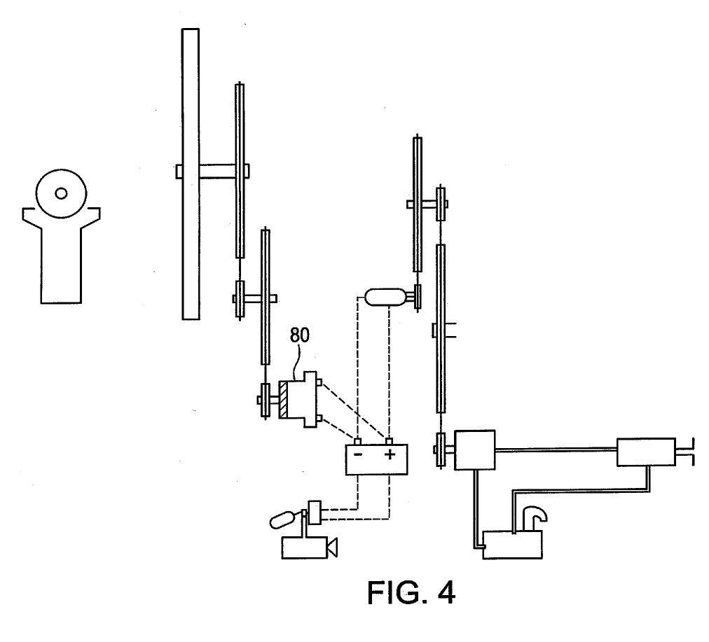

Reference to FIG. 4 is now had, wherein a turbine is shown with a power transmission device connected to an alternator generator 80, which is used to operate through gearing over a fluid power circuit. This circuit is then used to power an electric motor to operate a larger electrical generator or energy-producing device. A portion of the stored power is used to recirculate the motive fluid, this being unused fluid power or a portion of the electrical energy generated.

Thus, as can be seen, fluid motive power is utilized to generate sufficient electrical energy to do independent work, as well as to recirculate the fluid. The entire system can be used in series in a cascade fashion to increase the overall output for utilizing the same motive fluid.

Although a preferred embodiment has been disclosed for purposes of illustration, it should be understood that various changes and modifications and substitutions could be made in the preferred embodiment without departing from the spirit of the invention as defined by the claims which follow:

What is claimed is:

1. A recirculative power generation process comprising the steps of:
a) collecting and storing fluid;
b) using the stored fluid to drive a turbine;
c) using the turbine to drive a generator utilizing a transmission device incorporating a mechanical advantage;
d) storing the energy generated;
e) using the fluid from the turbine to drive another power transmission device;
f) collecting the fluid; and
g) utilizing some of the stored energy to recirculate the fluid to step a).

2. A process as in claim 1, wherein the fluid collected in step f) is utilized in a cascaded process step b).
